(19) United States
(12) Patent Application Publication
(10) Pub. No.: US 2023/0011287 A1
(43) Pub. Date: Jan. 12, 2023

(54) PREDICTIVE PLACEMENT OF STRUCTURED VERSIONS OF DIGITAL ASSETS IN UNSTRUCTURED 2-DIMENSIONAL OR 3-DIMENSIONAL SPACE

(71) Applicant: Haworth, Inc., Holland, MI (US)

(72) Inventors: Rupen CHANDA, Austin, TX (US); Kevin KOECHLEY, San Francisco, CA (US)

(73) Assignee: Haworth, Inc., Holland, MI (US)

(21) Appl. No.: 17/860,025

(22) Filed: Jul. 7, 2022

Related U.S. Application Data
(60) Provisional application No. 63/220,458, filed on Jul. 9, 2021.

(51) Int. Cl. G06Q 10/10

(52) U.S. Cl. CPC G06Q 10/103

(57) ABSTRACT

Systems and methods are provided for implementing a collaboration system for hosting collaboration sessions between client-side network nodes. The system includes logic to receive an identification of a virtual workspace from at least a first client-side network. The system includes logic to receive an updated digital asset and an identifier of the digital asset from a digital asset management system. The system includes logic to query the virtual workspace for a version of a particular digital asset within the virtual workspace having an identifier that matches the identifier of the updated digital asset. The system includes logic to save the updated digital asset as a subsequent version of the particular digital asset. The system includes logic to automatically place the subsequent version of the particular digital asset in a swim lane, for the version of the particular digital asset, within the virtual workspace.

### PRIORITY APPLICATION

This application claims the benefit of U.S. Provisional Patent Application No. 63/220,458, filed on 9 Jul. 2021, which application is incorporated herein by reference.

### FIELD OF INVENTION

The present technology relates to collaboration systems that enable users to actively collaborate in a virtual workspace in a collaboration session, in particular the technology relates to predictive and automatic placement of digital assets in the virtual workspace.

### BACKGROUND

Collaboration systems are used in a variety of environments to allow users to participate in content review and video conferencing. Users of a collaboration system can join collaboration sessions from locations around the world.

A workspace (or a virtual workspace or a digital canvas) associated with a collaboration session (as implemented by a collaboration system) can accumulate hundreds, thousands or even hundreds of thousands of digital assets such as documents, spreadsheets, slide decks, images, videos, line drawings, etc. over a period of time as participants collaborate on a project. As the number of digital assets increase, it becomes difficult to arrange the digital assets in the workspace. Some digital assets in particular may be related to other digital assets. For example, a recently added digital asset (e.g., an updated digital asset) may be a newer version of a previously added (e.g., particular) digital asset in the workspace. Participants may not be able to easily determine the relationships between the different versions of the digital assets if such relationships are not clearly indicated in the workspace. When there are a large number of digital assets in the workspace, it becomes difficult to manually arrange the digital assets in the workspace. It can take considerable amount of useful collaboration time of participants to go through the digital assets and manually indicate the relationships between relevant digital assets.

An opportunity arises to increase efficiency of collaboration meetings by automatically arranging digital assets in a workspace, and presenting the relationships between digital assets to participants so that they can efficiently and quickly navigate the content for the current meeting.

### SUMMARY

A system and method for operating a collaboration system are provided. The system includes a server-side network node of a collaboration system hosting a collaboration session between client-side network nodes. Each of the client-side network node can include a display having a physical display space and a processor. The server-side network node is configured with logic to implement the following operations. The server-side network node includes logic to establish a collaboration session between the client-side network nodes. The server-side network node includes logic to receive an identification of a virtual workspace from at least a first client-side network node wherein the virtual workspace comprises locations having virtual coordinates. The server-side network node includes logic to receive, from a digital asset management system, an updated digital asset and an identifier of the updated digital asset. The server-side network node includes logic to query the virtual workspace for a version of a particular digital asset within the virtual workspace having an identifier that matches the identifier of the updated digital asset. The identifier used to match the version of a particular digital asset with the updated digital asset can be a unique asset identifier. The server-side network node includes logic to save the updated digital asset as a subsequent version of the particular digital asset. The server-side network node includes logic to determine a location for placing the subsequent version of the particular digital asset in a swim lane, for the version of the particular digital asset, within the virtual workspace. The location for placing the subsequent version of the particular digital asset is determined in dependence on (i) a width of the subsequent version of the particular digital asset and (ii) a padding distance between the version of the particular digital asset and the subsequent version of the particular digital asset. The server-side network node includes logic to provide, to the client-side network nodes, a spatial event map identifying events in the virtual workspace, the events identified by the spatial event map are related to the version of the particular digital asset and the subsequent version of the particular digital asset within the virtual workspace. The spatial event map allows for rendering, in the display space on the display of each of the client-side network nodes, the version of the particular digital asset and the subsequent version of the particular digital asset in the swim lane within the virtual workspace.

The server-side network node is further configured with logic to create the swim lane within the virtual workspace for placing one or more digital assets. The height of the swim lane is equal to or greater than a height of a tallest of the one or more digital assets and a direction of the swim lane is along an orientation vector according to which the one or more digital assets are aligned in dependence on version numbers. The server-side network node is further configured with logic to place the subsequent version of the particular digital asset in the swim lane and adjacent to the version of the particular digital asset in the direction of the orientation vector.

The orientation vector can be along a horizontal axis in a two-dimensional virtual workspace. The orientation vector can be along a vertical axis in the two-dimensional virtual workspace. The orientation vector can be along an angle between the horizontal axis and the vertical axis in the two-dimensional workspace.

The orientation vector can be normal to a plane in a three-dimensional virtual workspace. The orientation vector can be along an angle between the normal to the plane and the surface of the plane in the three-dimensional workspace.

The server-side network node is further configured with logic to detect an interfering digital asset positioned in the virtual workspace. The interfering digital asset can be (i) at least partially covering an area in the swim lane and (ii) positioned at a location after the location of the version of the particular digital asset along the direction of the orientation vector. The server-side network node is further configured with logic to determine a target location in the swim lane to place the subsequent version of the particular digital asset. The target location is positioned in the swim lane along the direction of the orientation vector and does not overlap with the location occupied by the interfering digital asset.

The server-side network node is further configured with logic to parse a payload including the updated digital asset to extract metadata related to the updated digital asset. The metadata includes at least one of a user identifier, a user login, a title of the updated digital asset, an entity type of the updated digital asset, a project name, a project identifier and a server hostname. The server-side network node is further configured with logic to save the extracted metadata with the subsequent version of the particular digital asset.

The updated digital asset comprises of a plurality of child digital assets nested in the updated digital asset. The parsing of the payload further includes extracting identifiers for the child digital assets and saving the extracted metadata with the subsequent version of the particular digital asset.

The parsing of the payload further includes extracting metadata related to the child digital assets including at least one of columns, column display names, sort criterion, sort direction, group criterion, group method and group direction. The server-side network node is further configured with logic to implement operations including arranging the child digital assets in the swim lane in the tabular format using at least one of the extracted metadata. The tabular format displays the child assets nested inside the subsequent version of the particular digital asset in columns arranged in dependence upon at least one or more of the extracted metadata related to the child digital assets.

The server-side network node is further configured with logic to translating the metadata to identify at least one of an entity context, an entity identifier and an entity type. The server-side network node is further configured with logic to generate a transfer identifier comprising alpha numeric characters. The server-side network node is further configured with logic to associate (i) the at least one of the entity context, the entity identifier and the entity type and (ii) the transfer identifier with the updated digital asset, as received from the digital asset management system.

The querying the virtual workspace for the version of the particular digital asset further includes using the identifier of the updated digital asset to search a database storing the spatial event map including a plurality of digital assets and their respective identifiers. The plurality of digital assets includes the version of the particular digital asset with the identifier that matches the identifier of the updated digital asset.

The digital asset management system includes logic to generate the updated digital asset by changing at least one property of the version of the particular digital asset. The server-side network node is configured with logic to receive the updated digital asset from the digital asset management system. The updated digital asset includes at least one changed property. The change in at least one property of the version of the particular digital asset includes at least one of a color variance, a shadow variance, an angle of view variance, a light variance, an object location variance, an object sire variance and a color depth variance. It is understood the other types of variations to one or more properties of the version of the particular digital asset can be used by the digital asset management system to generate the updated digital asset.

The server-side network node is further configured with logic to parse a payload including the updated digital asset to extract metadata related to the updated digital asset. The metadata includes at least a time stamp indicating a date and a time of creation of the updated digital asset by the digital asset management system. The time stamp metadata of the updated digital asset can be used to assign a version number to the updated digital asset. The metadata also includes the unique asset identifier that is used to match the version of a particular digital asset with the updated digital asset.

The server-side network node is further configured with logic to determine a number of intermediate versions of the particular digital asset between a first version of the particular digital asset and a last version of the particular digital asset. The server-side network node is configured with logic to generate a plurality of graphical constructs to represent the intermediate versions of the particular digital asset. The server-side network node is configured with logic to provide, to the client-side network nodes, the plurality of graphical constructs for rendering in place of the intermediate versions of the particular digital asset.

A collaboration system hosting a collaboration session is disclosed. The collaboration system comprises a client-side network node including a display having a physical display space. The client-side network node can be configured with logic to implement the following operations. The client-side network node includes logic to parse a payload including the updated digital asset to extract metadata related to the updated digital asset. The metadata can include at least a time stamp indicating a date and a time of creation of the updated digital asset by the digital asset management system. The client-side network node includes logic to use the time stamp metadata of the updated digital asset to assign a version number to the updated digital asset. In one implementation, the client-side network node includes logic to use the unique asset identifier to find previous versions of the updated digital asset. The updated digital asset is then assigned a new version number.

Computer program products which can execute the methods presented above are also described herein (e.g., a non-transitory computer-readable recording medium having a program recorded thereon, wherein, when the program is executed by one or more processors the one or more processors can perform the methods and operations described above).

Other aspects and advantages of the present technology can be seen on review of the drawings, the detailed description, and the claims, which follow.

### BRIEF DESCRIPTION OF THE DRAWINGS

The technology will be described with respect to specific embodiments thereof, and reference will be made to the drawings, which are not drawn to scale, and in which:

FIGS. 1 and 2 illustrate example aspects of a system implementing predictive placement of digital assets in a virtual workspace in a collaboration session.

FIG. 3 presents processing engines and data structures to implement the predictive placement of digital assets.

FIG. 4A presents a configuration user interface that can be used to provide details for predictive placement of digital assets.

FIG. 4B presents an example workspace with versions of digital assets arranged in respective swim lanes.

FIGS. 5A and 5B present examples of metadata for digital assets sent by the digital asset management system to the collaboration system.

FIGS. 6A and 6B present flowcharts for server-side operations for receiving digital assets from a digital asset management system and processing the received digital assets for predictive placement in the workspace.

FIGS. 7A and 7B present flowcharts for client-side operations for rendering digital assets in the workspace and sending and receiving events to update the workspace.

FIG. 8 is a message sequence diagram presenting messages sent by various actors for predictive placement of digital assets in the workspace.

FIG. 9 is a schematic of a computer system implementing the technology for predictive placement of digital assets in a workspace.

### DETAILED DESCRIPTION

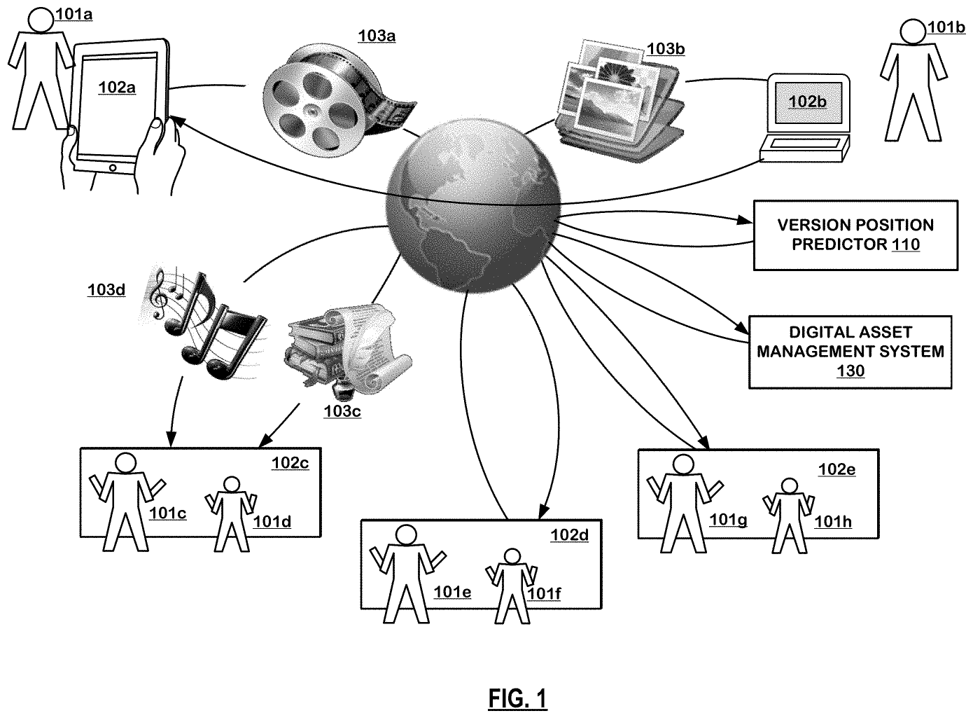

A detailed description of embodiments of the present technology is provided with reference to FIGS. 1-9.

The following description is presented to enable a person skilled in the art to make and use the technology and is provided in the context of a particular application and its requirements. Various modifications to the disclosed embodiments will be readily apparent to those skilled in the art, and the general principles defined herein may be applied to other embodiments and applications without departing from the spirit and scope of the present technology. Thus, the present technology is not intended to be limited to the embodiments shown, but is to be accorded the widest scope consistent with the principles and features disclosed herein.

### Introduction

The review process of a large number of digital assets, for example in a movie production, can be overwhelming for the production team. Without any organization of digital assets, the review process can become time consuming and disorganized. The collaboration and review process in many scenarios can incorporate moving between various versions of a digital asset before selecting a version for the next process step. Therefore, the collaboration participants who are reviewing the digital assets need to have an organized view of versions of each digital asset. The technology disclosed automatically translates the metadata of the digital assets received from a digital asset management system user to information that can be used to predict placement of digital assets and/or automatically place the digital assets in the virtual workspace. The technology disclosed thus improves the efficiency of multi-user collaboration sessions and reduces compute process time of client and server network nodes participating in the collaboration sessions.

More specifically, the technology disclosed is related to organizing and positioning digital assets in a virtual workspace (or workspace) for a collaboration session. As new digital assets are added to the workspace, the system includes logic to determine if a newly added digital asset is a new version of an existing digital asset in the workspace. If the newly added digital asset is a new version of an existing digital asset, the system can position the newly added digital asset in a swim lane that is dedicated to present versions of the same digital asset. The technology disclosed can arrange the versions of digital assets in various orientations in a 2-dimensional or a 3-dimensional space. The technology disclosed also allows users of the collaboration system to manually position the digital assets at an appropriate position in the virtual workspace. When placing a new digital asset in a swim lane, the technology disclosed can detect whether another digital asset is manually placed at the target location in a swim lane. The technology disclosed can determine a next available location in a swim lane in which the new version of the digital asset can be placed. The technology disclosed can then automatically place the new version in the next available location in the swim lane.

A collaboration system, which can be used to implement this predictive and automatic digital asset placement technology, is described below.

Some key elements of the collaboration system are presented below, followed by details of the technology disclosed.

### Virtual Workspace

In order to support an unlimited amount of spatial information for a given collaboration session, the technology disclosed provides a way to organize a virtual space termed the “virtual workspace”. The virtual workspace can be characterized by a multi-dimensional and in some cases two-dimensional plane with essentially unlimited extent in one or more dimensions for example, in such a way that new content can be added to the space. The content can be arranged and rearranged in the space, and a user can navigate from one part of the space to another. The virtual workspace can also be referred to as a workspace, a canvas or a digital canvas. A virtual workspace can have one or more digital canvases associated therewith.

Digital assets are arranged on (within) the virtual workspace and can be placed at any location. The predictive and automatic placement technology detects whether a new digital asset is a version of a previously present digital asset. The system can then organize versions of a same digital asset in swim lanes. The orientation of swim lanes can be pre-determined by the system or provided by the user. The digital assets can also be stacked on top of each other i.e., arranged along z-axis. The digital assets can be documents such as word processor files, spreadsheets, slide decks, notes, program code, etc. Digital assets can also be graphical objects such as images, videos, line drawings, annotations, etc. One or more digital displays in the collaboration session can display a portion of the workspace, where locations on the display are mapped to locations in the workspace.

### Viewport

One or more digital displays in the collaboration session can display a portion of the workspace, where locations on the display are mapped to locations in the workspace. A mapped area, also known as a viewport (e.g., a local client viewport or a local viewport of a client node) within the workspace is rendered on a physical screen space. Because the entire workspace is addressable using coordinates of locations, any portion of the workspace that a user may be viewing itself has a location, width, and height in coordinate space. The concept of a portion of a workspace can be referred to as a “viewport.” The coordinates of the viewport are mapped to the coordinates of the screen space. The coordinates of the viewport can be changed which can change the objects contained within the viewport and the change would be rendered on the screen space of the display client. Details of the workspace and the viewport are presented in U.S. patent application Ser. No. 15/791,351 (Atty. Docket No. HAWT 1025-1), entitled, “Virtual Workspace Including Shared Viewport Markers in a Collaboration System,” filed on Oct. 23, 2017, now issued as U.S. Pat. No. 11,126,325, which is fully incorporated into this application by reference.

### Spatial Event Map

The “unlimited workspace” problem includes the need to track how people and devices interact with the workspace over time. In order to solve this core problem, the technology disclosed includes a so-called “spatial event map”. The spatial event map contains information needed to define digital assets and events in a workspace. It is useful to consider the technology from the point of view of space, events, maps of events in the space, and access to the space by multiple users, including multiple simultaneous users.

A spatial event map contains content in the workspace for a given collaboration session. The spatial event map defines arrangement of digital assets on the workspace. The spatial event map contains information needed to define digital assets, their locations, and events in the workspace. A spatial events map system, maps portions of workspace to a digital display e.g., a touch enabled display. Details of workspace and spatial event map are presented in U.S. application Ser. No. 14/090,830 (Atty. Docket No. HAWT 1011-2), entitled, “Collaboration System Including a Spatial Event Map,” filed Nov. 26, 2013, now issued as U.S. Pat. No. 10,304,037, which is fully incorporated into this application by reference.

In the unstructured datafinformation organization model (e.g., in a spatial event map), the system can arrange the digital assets in any geometric direction (left, right, up, down or in any angle, orientation that the user likes) and in any position in the 2D or 3D space. Unstructured methods of organizing information are helpful in creative process. For example, thousands or hundreds of thousands of images can be generated during production of an animated movie. Hundreds of versions of a same image may be created with variations in colors, lighting, etc. Video, artwork, sketches/clip art, 3D models are some examples of the types of digital assets for which version management is very useful. These types of assets convey multi-dimensional information unlike digital assets that include textual type information. Examples of variance that are used for generating versions of such digital assets include color variance, shadow variance, angle of view variance, light variance, object location variance, color depth variance, and many more.

Information related to locations of digital assets on display of a client-side node can be included in the spatial event map. For example, the spatial event map can include information about digital assets that can uniquely identify the digital assets. Such information can include a unique identifier of a digital asset, a type of the digital asset, a source of record application that generated the digital asset etc. Combinations of such information can also be used to identify digital assets in the spatial event map. The source of record application (or a source system such as a digital asset management system) from where the digital asset is received may also be stored as part of the data structure storing metadata about the digital asset. The spatial event map can also include information about orientation vector or swim lane dedicated for rendering the versions of a digital asset. The information can indicate orientation (horizontal, vertical, or any other direction) of the swim lane. It can also include arrangement of versions (or direction) in the swim lane such as from left to right or from top to bottom, etc. The spatial event map can include information about any grouping of digital assets that can be applied. For example, more than one digital asset can belong to one group. When placing digital assets in a swim lane, the digital assets belonging to a group can be placed together in the same swim lane. As new versions of the digital assets or groups of digital assets are received by the collaboration system, the next versions can be placed in a next column in the same swim lane along the direction of the orientation vector.

The spatial event map can include information about the versions of a digital asset, such as the version identifier, version location in the orientation vector or swim lane for the digital asset, column identifier in the swim lane in which the current version is placed, etc. The spatial event map can include a time stamp for a version which can indicate the time and date at which this version was received by the collaboration system from the digital asset management system. A separate time stamp can also indicate the creation time and date at which the source of record application generated the digital asset. This information can be used in version numbering of the digital assets for organizing in swim lanes.

The spatial event map can include information about the swim lane such as the orientation of the swim lane (along X-axis, Y-axis and Z-axis). The orientation can be along any direction in the 2D or 3D space. The spatial event map can include information about the position of the swim lane in the 2D or 3D space. The spatial event map can include information about the height or width of the swim lane and the column width of columns in the swim lane in which versions of digital assets are positioned. The height, width, columns and location of the swim lane can be automatically adjusted based on the information related to the new/updated digital asset or the previous digital assets (versioned or non-versions unrelated digital assets).

### Space

In order to support an unlimited amount of spatial information for a given collaboration session, we provide a way to organize digital assets in a virtual space termed as the workspace, which can, for example, be characterized by a 2-dimensional plane (along X-axis and Y-axis) with essentially unlimited extent in one or both of the dimensions for example. The workspace is organized in such a way that new content such as digital assets can be added to the space, that content can be arranged and rearranged in the space, that a user can navigate from one part of the space to another, and that a user can easily find needed things in the space when it is needed. The technology disclosed can also organize content on a 3-dimensional workspace (along X-axis, Y-axis, and Z-axis).

### Events

Interactions with the workspace are handled as events. People, via tangible user interface devices, and systems can interact with the workspace. Events have data that can define or point to a target digital asset to be displayed on a physical display, and an action as creation, modification, movement within the workspace and deletion of a target digital asset, and metadata associated with them. Metadata can include information such as originator, date, time, location in the workspace, event type, security information, and other metadata.

Tracking events in a workspace enables the system to not only present the spatial events in a workspace in its current state, but to share it with multiple users on multiple displays, to share relevant external information that may pertain to the content and the understanding of how the spatial data evolves over time. Also, the spatial event map can have a reasonable size in terms of the amount of data needed, while also defining an unbounded workspace.

### Environment

FIG. 1 illustrates example aspects of a digital display collaboration environment. In the example, a plurality of users 101a-h (collectively 101) may desire to collaborate with each other in the creation, review, and editing of digital assets such as complex images, music, video, documents, and/or other media, all generally designated in FIG. 1 as 103a-d (collectively 103). The participants or users in the illustrated example use a variety of computing devices configured as electronic network nodes, in order to collaborate with each other, for example a tablet 102a, a personal computer (PC) 102b, many large format displays 102c, 102d, 102e (collectively devices 102), and one or more mobile computing devices with small format displays. In the illustrated example the large format display 102c, which is sometimes referred to herein as a “wall”, accommodates more than one of the users, (e.g. users 101c and 101d, users 101e and 101f, and users 101g and 101h).

In an illustrative embodiment, a display array can have a displayable area usable as a screen space totaling on the order of 6 feet in height and 30 feet in width, which is wide enough for multiple users to stand at different parts of the wall and manipulate it simultaneously. It is understood that large format displays with displayable area greater than or less than the example displayable area presented above can be used by participants of the collaboration system. The user devices, which are referred to as client-side network nodes, have displays on which a screen space is allocated for displaying events in a workspace. The screen space for a given user may comprise the entire screen of the display, a subset of the screen, a window to be displayed on the screen and so on, such that each has a limited area or extent compared to the virtually unlimited extent of the workspace.

The collaboration system of FIG. 1 can include a version position predictor 110 which can include the logic to detect whether a digital asset received from a digital asset management system 130 is a new version of an existing digital asset present in the workspace. The version position predictor 110 can include logic to automatically arrange the versions of a digital asset in swim lanes. It can also include logic to automatically arrange and adjust the swim lanes on the workspace and determine the positions of versions of digital assets in a swim lane. The digital asset management system 130 can be an external system that generates digital assets. Such systems can include Word processor systems that are used to generate documents, image or video generation systems that are used to generate or edit images and videos, etc. Examples of digital asset management systems can include Adobe™ tools, AutoDesk™ tools like Shotgun™, Microsoft™ Office tools like MS Word™, Excel™ etc. The collaboration system can include an additional component or plug-in that can connect the collaboration system with one or more digital asset management systems to receive digital assets.

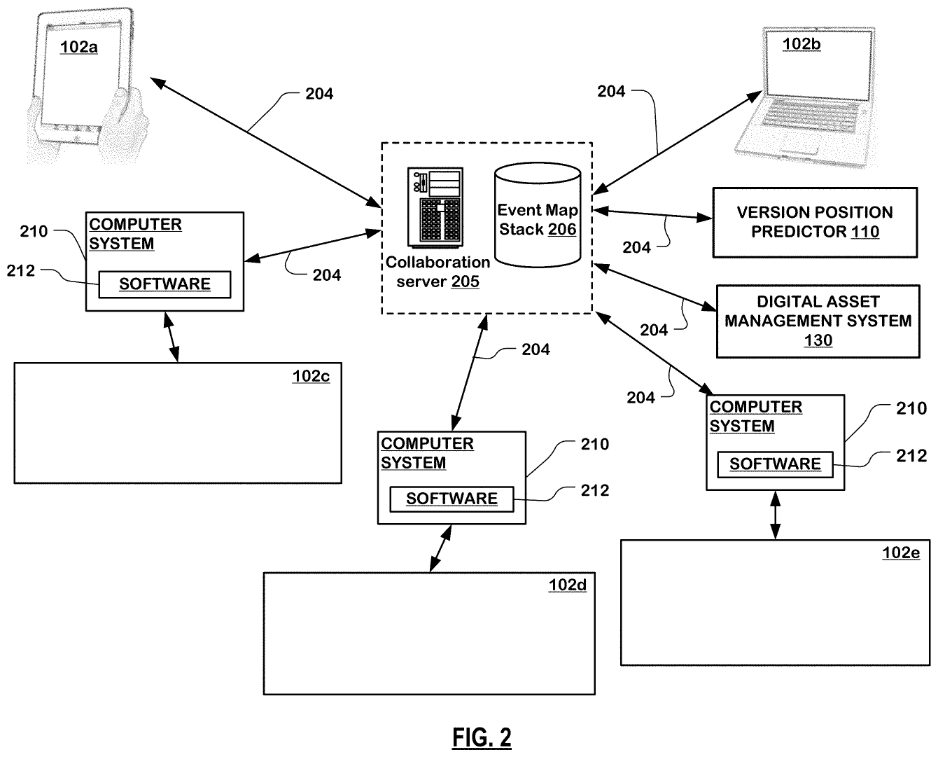

FIG. 2 illustrates additional example aspects of a digital display collaboration environment. As shown in FIG. 1, the large format displays 102c, 102d, 102e sometimes referred to herein as “walls” are controlled by respective client-side, communication networks 204, which in turn are in network communication with a central collaboration server 205 configured as a server-side physical network node or nodes, which has accessible thereto a database 206 storing spatial event map stacks for a plurality of workspaces. The database 206 can also be referred to as an event map stack or the spatial event map as described above. The version position predictor 110 can be implemented as part of the collaboration server 205 or it can be implemented separately and can communicate with the collaboration server 205 via the communication networks 204.

As used herein, a physical network node is an active electronic device that is attached to a network, and is capable of sending, receiving, or forwarding information over a communication channel. Examples of electronic devices which can be deployed as network nodes, include all varieties of computers, workstations, laptop computers, handheld computers and smart phones. As used herein, the term “database” does not necessarily imply any unity of structure. For example, two or more separate databases, when considered together, still constitute a “database” as that term is used herein.

The application running at the collaboration server 205 can be hosted using Web server software such as Apache or nginx, or a runtime environment such as node.js. It can be hosted for example on virtual machines running operating systems such as LINUX. The server 205 is illustrated, heuristically, in FIG. 2 as a single computer. However, the server architecture can involve systems of many computers, each running server applications, as is typical for large-scale cloud-based services. The server architecture includes a communication module, which can be configured for various types of communication channels, including more than one channel for each client in a collaboration session. For example, with near-real-time updates across the network, client software can communicate with the server communication module using a message-based channel, based for example on the WebSocket protocol. For file uploads as well as receiving initial large volume workspace data, the client software can communicate with the server communication module via HTTPS. The server can run a front-end program written for example in JavaScript served by Ruby-on-Rails, support authentication/authorization based for example on OAuth, and support coordination among multiple distributed clients. The server communication module can include a message-based communication protocol stack, such as a WebSocket application, that performs the functions of recording user actions in workspace data, and relaying user actions to other clients as applicable. This system can run on the node.JS platform for example, or on other server technologies designed to handle high-load socket applications.

The database 206 stores, for example, a digital representation of workspace data sets for a spatial event map of each session where the workspace data set can include or identify events related to objects displayable on a display canvas, which is a portion of a virtual workspace. A workspace data set can be implemented in the form of a spatial event stack, managed so that at least persistent spatial events (called historic events) are added to the stack (push) and removed from the stack (pop) in a first-in-last-out pattern during an undo operation. There can be workspace data sets for many different workspaces. A data set for a given workspace can be configured in a database or as a machine-readable document linked to the workspace. The workspace can have unlimited or virtually unlimited dimensions. The workspace data includes event data structures identifying digital assets displayable by a display client in the display area on a display wall and associates a time and a location in the workspace with the digital assets identified by the event data structures. Each device 102 displays only a portion of the overall workspace. A display wall has a display area for displaying objects, the display area being mapped to a corresponding area in the workspace that corresponds to a viewport in the workspace centered on, or otherwise located with, a user location in the workspace. The mapping of the display area to a corresponding viewport in the workspace is usable by the display client to identify digital assets in the workspace data within the display area to be rendered on the display, and to identify digital assets to which to link user touch inputs at positions in the display area on the display.

The server 205 and database 206 can constitute a server-side network node, including memory storing a log of events relating to digital assets having locations in a workspace, entries in the log including a location in the workspace of the digital asset of the event, a time of the event, a target identifier of the digital asset of the event, as well as any additional information related to digital assets, as described herein. The server 205 can include logic to establish links to a plurality of active client-side network nodes (e.g., devices 102), to receive messages identifying events relating to modification and creation of digital assets having locations in the workspace, to add events to the log in response to said messages, and to distribute messages relating to events identified in messages received from a particular client-side network node to other active client-side network nodes.

The logic in the server 205 can comprise an application program interface, including a specified set of procedures and parameters, by which to send messages carrying portions of the log to client-side network nodes, and to receive messages from client-side network nodes carrying data identifying events relating to digital assets which have locations in the workspace. Also, the logic in the server 205 can include an application interface including a process to distribute events received from one client-side network node to other client-side network nodes.

The events compliant with the API can include a first class of event (history event) to be stored in the log and distributed to other client-side network nodes, and a second class of event (ephemeral event) to be distributed to other client-side network nodes but not stored in the log.

The server 205 can store workspace data sets for a plurality of workspaces and provide the workspace data to the display clients participating in the session. The workspace data is then used by the computer systems 210 with appropriate software 212 including display client software, to determine images to display on the display, and to assign digital assets for interaction to locations on the display surface. The server 205 can store and maintain a multitude of workspaces, for different collaboration sessions. Each workspace can be associated with an organization or a group of users and configured for access only by authorized users in the group.

In some alternatives, the server 205 can keep track of a “viewport” for each device 102, indicating the portion of the display canvas (or canvas) viewable on that device, and can provide to each device 102 data needed to render the viewport. The display canvas is a portion of the virtual workspace. Application software running on the client device responsible for rendering drawing objects, handling user inputs, and communicating with the server can be based on HTML5 or other markup-based procedures and run in a browser environment. This allows for easy support of many different client operating system environments.

The user interface data stored in database 206 includes various types of digital assets including graphical constructs, such as image bitmaps, video objects, multi-page documents, scalable vector graphics, and the like. The devices 102 are each in communication with the collaboration server 205 via a communication network 204. The communication network 204 can include all forms of networking components, such as LANs, WANs, routers, switches, Wi-Fi components, cellular components, wired and optical components, and the internet. In one scenario two or more of the users 101 are located in the same room, and their devices 102 communicate via Wi-Fi with the collaboration server 205.

In another scenario two or more of the users 101 are separated from each other by thousands of miles and their devices 102 communicate with the collaboration server 205 via the internet. The walls 102c, 102d, 102e can be multi-touch devices which not only display images, but also can sense user gestures provided by touching the display surfaces with either a stylus or a part of the body such as one or more fingers. In some embodiments, a wall (e.g. 102c) can distinguish between a touch by one or more fingers (or an entire hand, for example), and a touch by the stylus. In an embodiment, the wall senses touch by emitting infrared light and detecting light received; light reflected from a user's finger has a characteristic which the wall distinguishes from ambient received light. The stylus emits its own infrared light in a manner that the wall can distinguish from both ambient light and light reflected from a user's finger. The wall 102c may, for example, be an array of Model No. MT553UTBL MultiTaction Cells, manufactured by MultiTouch Ltd, Helsinki, Finland, tiled both vertically and horizontally. In order to provide a variety of expressive means, the wall 102c is operated in such a way that it maintains “state.” That is, it may react to a given input differently depending on (among other things) the sequence of inputs. For example, using a toolbar, a user can select any of a number of available brush styles and colors. Once selected, the wall is in a state in which subsequent strokes by the stylus will draw a line using the selected brush style and color.

### Predictive and Automatic Placement of Digital Assets

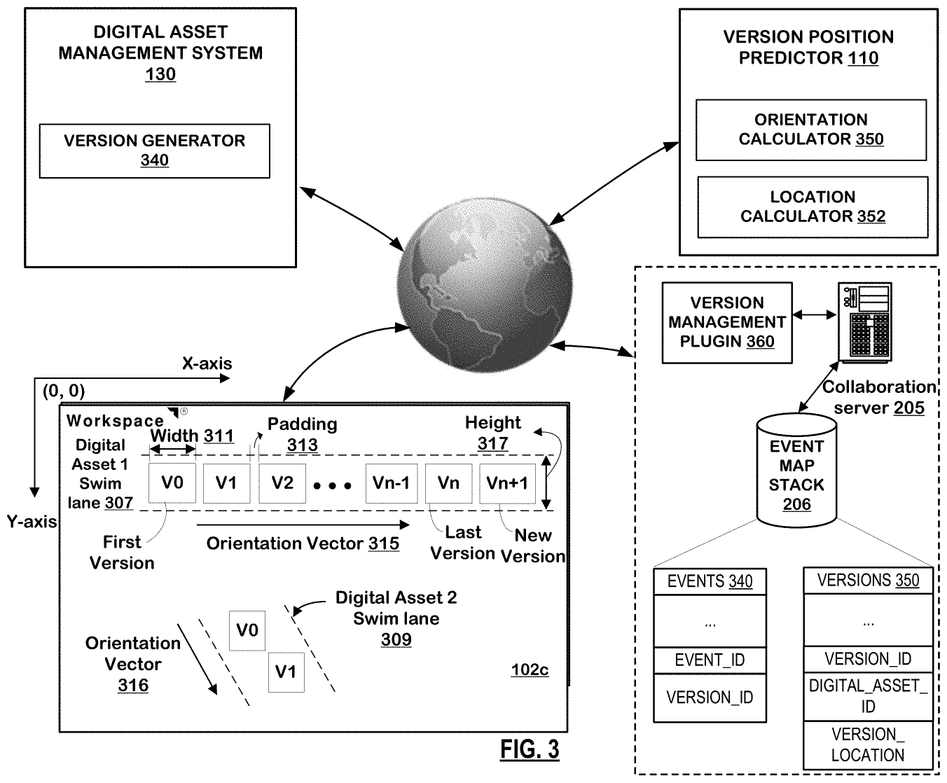

FIG. 3 presents processing engines and data structures that can be used to implement predictive and automatic placement of digital assets in a workspace. The digital asset management system 130 can include a version generator 340 that can generate a new digital asset which is a next version of a previously generated digital asset. A new version of a digital asset or any other type of digital information, document, image, video, audio etc. is in many cases similar to the previous version with some minor characteristic change. Multiple versions of the same digital asset are generated to incorporate edits.

The technology disclosed is related to managing versions of digital assets in a collaboration environment for conducting collaboration sessions. The digital asset management system can create newer version of digital assets (e.g., a new version of an image with new color pattern) and send it to the collaboration system. In some cases, a user, using the structured information creation tool can create new version of an existing digital asset i.e., version 1 (or V1). The technology disclosed can place a new version of a digital asset i.e., V2, close to (e.g., within close proximity in a swim lane within the virtual workspace) the previous version (i.e., V1) of the same digital asset. The collaboration server can include a version management plugin 360 which can include logic to receive the digital asset from the digital asset management system and process metadata or other information that is associated with the digital asset.

In the structured data/information organization model, users can place data in files, folders or groups. It can be represented by various forms of tree views like file explorer in an operating system, or file/folder structure of any information repository system. Such a structured way of organizing information makes re-arrangement or changes in organization of digital assets difficult, as contextual correlation is one dimensional. Consider a file that is inside a folder tree, where it is desirable to show that this file has some correlation with another file in a different folder tree. In a structured arrangement it is difficult to express this relationship. Such relationships can be identified relatively easily in an unstructured organization model provided by a workspace and stored in a spatial event map.

An example workspace is presented on a large display 102c as shown in FIG. 3. A two-dimensional (or 2D) workspace provides a surface area in 2D (along X-axis, and Y-axis) for organizing digital assets and a 3-dimensional workspace and provides a 3D volume or a 3D space (along X-axis, Y-axis, and Z-axis) for arranging digital assets. A benefit of spatial event map model is that information can be moved and placed in any of these dimensions very quickly in a single user action, and the spatial event map model lets users express new correlations very easily. The spatial event map can store the locations and relationships between the digital assets. The technology disclosed can segment the 2D/3D virtual workspace into swim lanes to arrange digital assets in separate swim lanes. Horizontal, vertical, or any angular positioning and layering can represent the orientation of swim lanes. Versions of digital assets are arranged along a direction in the swim lane such as from left to right, top to bottom, etc. When structured information creation tools (e.g., Adobe™ tools, Microsoft™ tools like MS Word™, Excel™ etc.) send a digital asset to the collaboration system, the collaboration system can process the metadata of the digital assets and place the digital assets in locations within swim lanes.

The example workspace shown in FIG. 3, as displayed on a large format display 102c, arranges digital assets in a 2-dimensional (or 2D) area along the X-axis and the Y-axis. The origin position (0, 0) of the 2D coordinates is at the top left corner of the workspace. The origin value for X-axis and Y-axis can be positioned at any location on workspace bottom left corner, or at a pre-defined distance from the top left or bottom left corners. Two swim lanes 307 and 309 are shown. The swim lane 307 arranges versions of a digital asset 1 and the swim lane 309 arranges versions of a digital asset 2. The versions of digital asset 1 are positioned from left to right in swim lane 307 while the versions of digital asset 2 are diagonally positioned from top to bottom in swim lane 2.

The versions can be arranged in columns in a swim lane. Each column can have a “width” 311 equal to the width of the digital asset. Versions of a digital asset can be separated by a distance from each other which is referred to as “padding” distance 313 as indicated in swim lane 307. The direction of a swim lane is along an orientation vector. The height 317 of a swim lane can be equal to the height of a tallest digital asset in the swim lane or greater than the height of the tallest digital asset. Alternatively, the height of the swim lane can be predetermined and then the heights of the digital assets can be adjusted to fit into the height of the swim lane by scaling the size (height and width) of the digital assets or by just reducing the height of the digital asset without reducing the width. Similarly, the size of the digital assets can be increased based on the height and/or width of the swim lane. The direction of the orientation vectors 315 and 316 can be provided by a user or participant using a configuration page or the direction of the orientation vectors 315 and 316 can be calculated using an orientation calculator 350 which can be part of the version position predictor 110. The new version is placed at a location next to the previous version in the respective swim lane (along the orientation vector).

In FIG. 3, the orientation vector 315 proceeds in a left-to-right direction and the orientation vector 316 proceeds in a top-to-bottom direction. However, the orientation vector can proceed in any direction, such as right-to-left and bottom-to-top. A location calculator 352 can calculate the location in the workspace for placing the new version of the digital asset. The location calculator 352 can consider other digital assets that may have been manually placed in the swim lane and partially or fully occupy the target location in swim lane. The location calculator can find an empty space that in the swim lane in which the new version can fit.

The technology disclosed, based on the user's placement of one or more previous versions of a digital asset, can predict where to place the next version of the same asset. For example, if the collaboration system receives V2 of the digital asset 1 as shown in FIG. 3, the version position predictor can create an orientation vector with a direction depending upon V1's placement relative to V0. The version position predictor 110 can then create the swim lane (or a layer if vector is along Z-axis) and place the new version in the next available an open slot/space in the swim lane. The system includes logic to traverse along the swim lane and find next appropriate slot for placing the new version. The last version of the digital asset 1 placed in the swim lane 307 is labeled as “Vn”. When the system receives a new version of the digital asset 1 (i.e., Vn+1), the version position predictor 110 places the new version “Vn+1” in the swim lane 307 after the last version “Vn” with a padding distance equal to the padding distance 313 between versions of the digital asset 1. The padding distance can be provided as input by a user or the version position predictor 110 can use a default value of the padding distance value. Note that when a swim lane has many versions of a digital asset, the system can display graphical objects such as dark colored circles as shown between the version “V2” and the version “Vn−1” in the swim lane 307 to indicate to the user that there are additional versions of the digital asset which are not displayed due to lack of available space on the digital display. Other types of graphical objects can be used to illustrate the versions that are not displayed in the swim lane. The number of graphical objects (such as dark colored circles) can be equal to the number of versions of a digital asset that are not displayed in the swim lane. The swim lane 309 is diagonally oriented along the orientation vector 316 and arranges versions of the digital asset in a top-to-bottom direction. Two versions of the digital asset 2, i.e., a first version “V0” and a second version “V1” are shown in the swim lane 309. When a new version of the digital asset 2 is received, it is placed in the swim lane 309, below the second version “V1”.

With respect to layering on the Z-axis, consider a workspace containing first (V0) and second (V1) versions of an image. The second version is V1 is placed on top of V0 (like a deck of images). Now when the collaboration system receives a third version V2 of the same image the orientation calculator 350 calculates that the third version V2 is to be placed on top of the V1 so that the images are stacked on top of each other. V1 is placed in higher Z order on top of V0. As the versions are stacked on one another, their x-axis (horizontal) locations and/or their y-axis (vertical) locations can be adjusted as well, so that digital assets on a lower Z-axis layer can still be visible even though they are below digital assets on a higher Z-axis layer. Therefore, the system can predict placement of new versions of digital asset based on how previous versions are arranged. In another implementation, the system can present a configuration page to the user to select an orientation for placing the next version of the digital asset in the workspace.

The system can track a digital asset's version name like version 0 (V0), version 1 (V1), version 2 (V2) etc. When the collaboration system has versions 1 and 2 of a digital asset and then the collaboration system receives version 10 of the same digital asset. The system can determine that there is a gap between version 2 and version 10. The system can create a graphical construct between version 2 and version 10 to illustrate the size of the version gap. A user viewing the arrangement of versions will easily understand that there are additional versions between version 2 and version 10 which are not displayed. A separate graphical construct can be created for each version that is missing or one larger graphical construct can be created to encompass the multiple missing versions. Therefore, the technology disclosed can predictively position versions of digital asset or any type of graphical objects in the workspace. The system can automatically place versions of digital assets in any of in 2D/3D workspace in respective swim lane.

FIG. 3 presents example data structures that can store information related to events and versions in the spatial event map. An events data structure 341 can store an event identifier (event_ID) and a version identifier (version_ID). A versions data structure 351 can store a version identifier (version_ID), a digital asset identifier (digital_asset_ID), and a version location in the workspace (version_location). The data structures and respective data fields are shown for illustration purposes and a complete set of data structures and respective data fields are for a spatial event map are not presented here. Additional data structures can store locations of swim lanes, width, height, and padding distances for respective swim lanes, direction of orientation vectors along which swim lanes are positioned, etc.

### Configuration Tool for Predictive Placement of Digital Assets

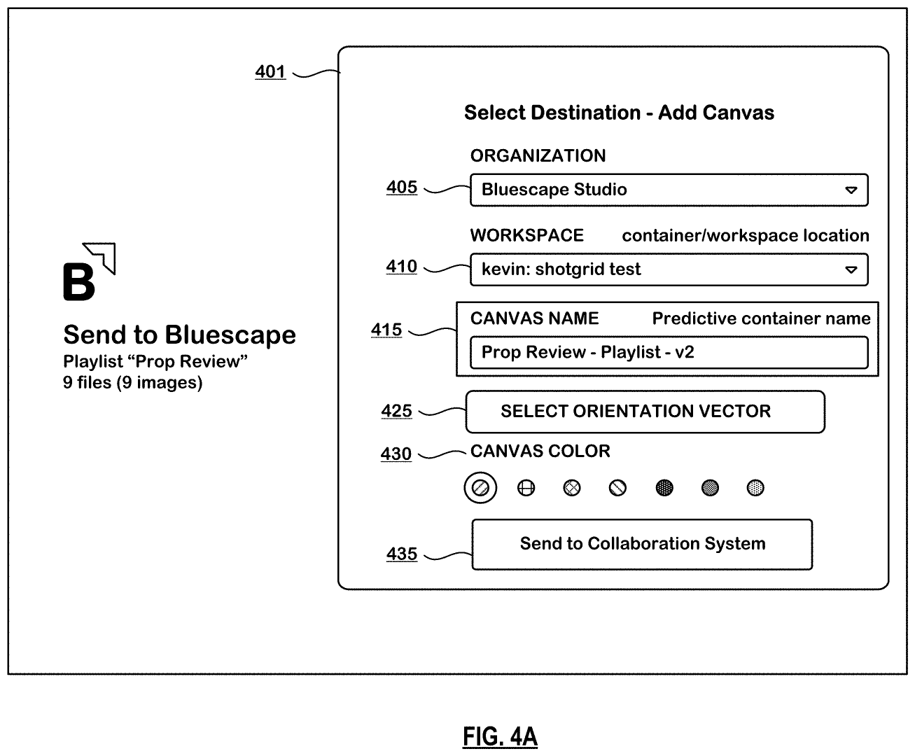

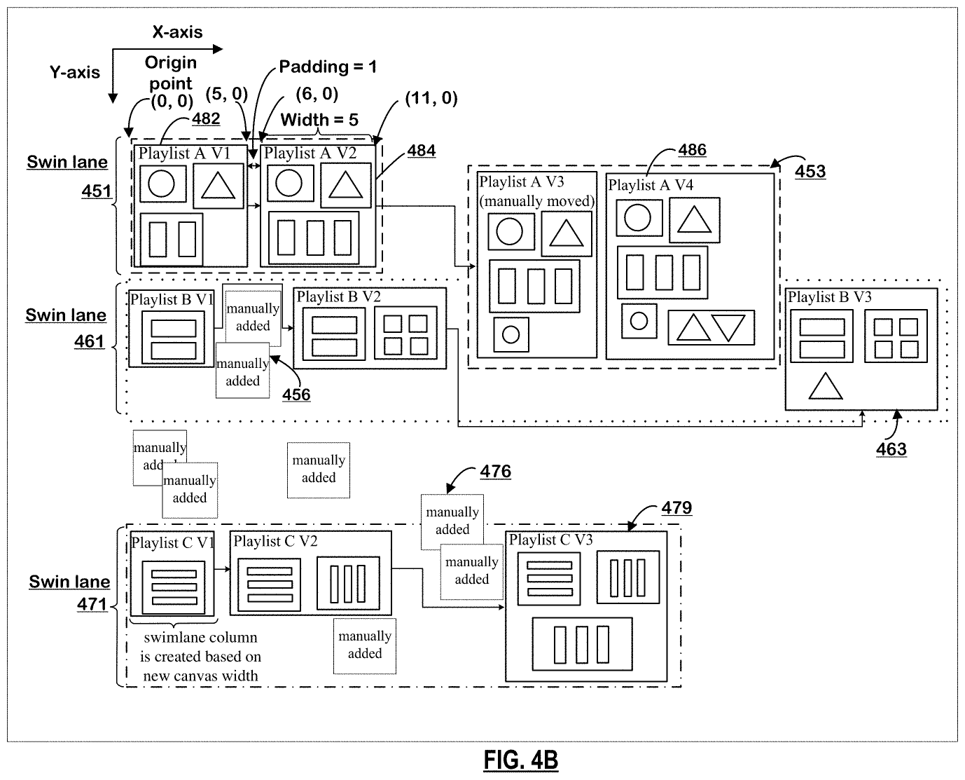

FIG. 4A presents an example “configuration page” 401 as presented to a user or a participant of the collaboration session. The system can include a “configuration tool” which can present the configuration page to the user or the participant. The configuration page can be presented to the user or the participant of the collaboration session when a new digital asset is received from the digital asset management system. The user can provide the information such as the organization, workspace and canvas in which the received digital asset be placed. For example, the configuration page 401 presents a drop down selection menu 405 which can be used to select an “organization” to which the incoming digital asset will be sent to. The organization input field of the drop down selection menu 405 can be used to organize content. An organization can represent a company, a department within a company or a group within a department, etc. Therefore, this field can be used to arrange the virtual workspaces belonging to different organizations, departments or groups, etc. The “workspace” input field 410 can be used to select a workspace (or a virtual workspace) in which the digital asset is saved. The user can select a target workspace from the drop down menu. The system can also present a canvas name input field 415 which can be used to select the canvas name in which the digital asset is saved. The canvas (or display canvas or digital canvas) is a portion of the virtual workspace. The canvas can be used to organize or arrange the digital assets in a workspace. The system can present a. “select orientation vector” input field 425 to allow the user to select an orientation vector which can be used for placement of swim lane. The user can select an existing orientation vector from the workspace or provide input to create a new orientation vector. The system can provide a graphical user interface on which the user can draw an orientation vector in a 2D or 3D space. The user can also select color for the canvas by selecting one of the available color options presented in the “canvas color” selection menu 430. The user can press “send to collaboration system” button 435 to send the digital asset to the target canvas in the selected workspace.

The configuration page can also prompt the user to enter additional information such as the direction or orientation of the swim lane in which versions of the digital asset are placed. In another implementation, the system can determine the orientation of the swim lane using direction determined by previously positioned digital assets.

In one implementation, the technology disclosed includes logic to link the swim lanes in the workspace with the asset management tools. The collaboration system can include logic to receive a signal from asset management tool indicating a new version is being created. The collaboration system can also receive a link to a location where the new version of the digital asset is stored. The collaboration system can access the new version, get the new version of the digital asset and place it in the respective swim lane. In one implementation, the asset management tool can send the new version to the collaboration system. The collaboration system can place the digital asset in the next available location (or column) in the swim lane linked to the digital asset management system.

FIG. 4B presents an example workspace with three swim lanes 451, 461, and 471. The origin point for the horizontal (X-axis) and vertical (Y-axis) is at the top left corner labeled (0, 0). In the example shown in FIG. 4B, the system starts placing the swim lanes from the top left corner (i.e., at the origin). The first swim lane 451 is placed at the top left corner, then the second swim lane is placed at the same X-axis location i.e., x=0 but it is moved down along the Y-axis by a distance equal to the height of the first swim lane which may be equal or slightly greater than the height of the digital asset placed in the swim lane.

A user can manually place digital assets such as sticky notes etc. in a swim lane such as indicated by a label 456. The user can also move digital assets placed in a swim lane to other locations on the workspace. For example, the digital assets in a box 453 are moved below from swim lane 451 to partially cover space in swim lane 461. Therefore, when a new version 463 is to be placed in swim lane 461, the version position predictor selects a location which is positioned after the box 453 containing manually placed digital assets. Similarly, digital assets 479 are positioned in the swim lane 471 after manually placed sticky notes 476. Graphical identifiers, such as lines and arrows can be implemented to clarify relationships between digital assets when other digital assets get in the way of the original swim lane, as discussed above.

The technology disclosed provides various models for arranging and grouping digital assets. In the example, presented above, the digital assets are arranged in swim lanes. The system provides other types of containers such as a grid, or list type containers as well for arranging versions of digital assets. The containers can be considered as information classifier(s) in 2D or 3D space. Tree type structures can also be created by placing versions of digital assets as nodes in a tree. Nested structures can also be created by placing versions of digital assets in a nested form. For example, a digital asset can include several child digital assets. The first version of a digital asset in swim lane 451 is labeled as “playlist A V1” (482). In this example, the digital asset 482 is a “playlist” type digital asset that can contain one or more child digital assets. The digital asset 482 contains three graphical objects, the first graphical object contains a circle-shaped object, the second graphical object contains a triangle-shaped object and a third digital asset contains two rectangular-shaped objects. Changes to existing child digital objects can be made in next versions of parent digital assets. New child objects can be added and existing child objects can be removed from the parent digital asset. For example, the version 4 of the digital asset in swim lane 451 is labeled as “playlist A V4” (486) and contains five child digital assets.

The technology disclosed includes logic to determine a location in the swim lane for placing the next version of a digital asset. The system can calculate this location by including a width of the digital asset and a padding distance between two versions of the digital asset. For example, in swim lane 451, the padding distance between a first version of digital asset 482 and a second version of digital asset 484 is “1”. The width of the first version of the digital asset 484 is “5”. The system calculates the location (top left corner) for placing the second version of the digital asset 484 in the swim lane 451 by adding the padding distance (a value of “1”) and the width (a value of “5”) to the first version 482's (top left corner—location (0, 0)) thus resulting in (0+1+5, 0)=(6, 0). The position of top right corner of the box containing the second version is calculated by adding the width of the second version (i.e., “5”) to the position of the top left corner of the box which is (6, 0) thus resulting in (6+5, 0)=(11, 0). Note that the location along the Y-axis does not change and remains same (i.e., a value of “0) because the location of the second version (along Y-axis) is the same as the first version's location (along Y-axis) and both versions are located at the origin (a value of “0”) along Y-axis.

The system can get user input for placing the first version (or base version) of a digital asset in the workspace. The user can indicate where she wants to place the base version of the asset in an existing generic container like a swim lane, grid, or list type arranged or create a new container for placing the base version. After the initial placement of the base version of the digital asset, the user can move around the container or asset in the 2D or 3D space.

### Metadata Translation for Predictive Placement of Digital Assets

The digital asset management system 130 can assign a unique identifier to the digital asset or a collection of digital assets. The unique identifier and other information related to the digital asset can be stored as metadata with the digital asset or a collection or group of digital assets generated by the digital asset management system 130. The metadata is transferred with the digital asset from digital asset management system to the collaboration system. This metadata is stored with the digital asset or group of digital assets as key-value pairs (e.g., in JSON-LD format). The values in the metadata can uniquely identify digital assets based on the source of record or the type of digital asset in the source of record. For example, consider AutoDesk™'s ShotGrid™ (formerly Shotgun) tool, which is used for creative project management of film, TV, games, etc. It can be used as a source of record application (or a digital asset management system) and a user can send digital assets such as “playlists” and “shots” from ShotGrid™ to the collaboration system. ShotGrid™ playlists are sets of digital assets which can be versions of a same digital asset grouped together. Therefore, when a playlist entity is sent to the collaboration system, it can contain more than one digital asset. Note that in this example, the playlist entity is being treated as a single digital asset for version management and organization. The source of record application (i.e., ShotGrid™) assigns a unique “entityId” and “entityType” values to the playlist digital asset (or entity) sent to the collaboration system which can be used to uniquely identify the playlist digital asset in the workspace. The collaboration system can query a database such as the event stack map database 206 that stores the spatial event map including a plurality of digital assets and their respective identifiers. The database can also store the version numbers with respective versions of the same digital asset. The collaboration system can query the database 206 using the “entity ID” received from the digital asset management system as part of the metadata with the digital asset. The results of the query can indicate that “n” number of matching digital assets have been previously received by the collaboration system having the same the unique identifier e.g., the “entityID”. The collaboration system can then assign the newly received digital asset, an “n+1” version number with the same “entityID”. The collaboration system can then store the new version in the database 206 along with the unique identifier and the version number.

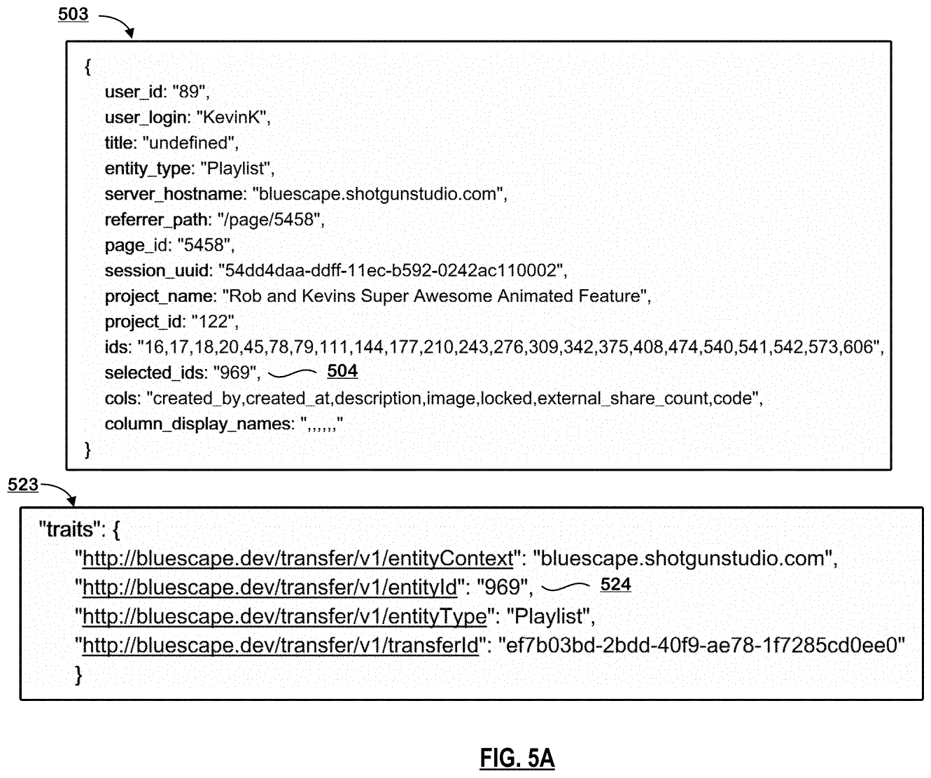

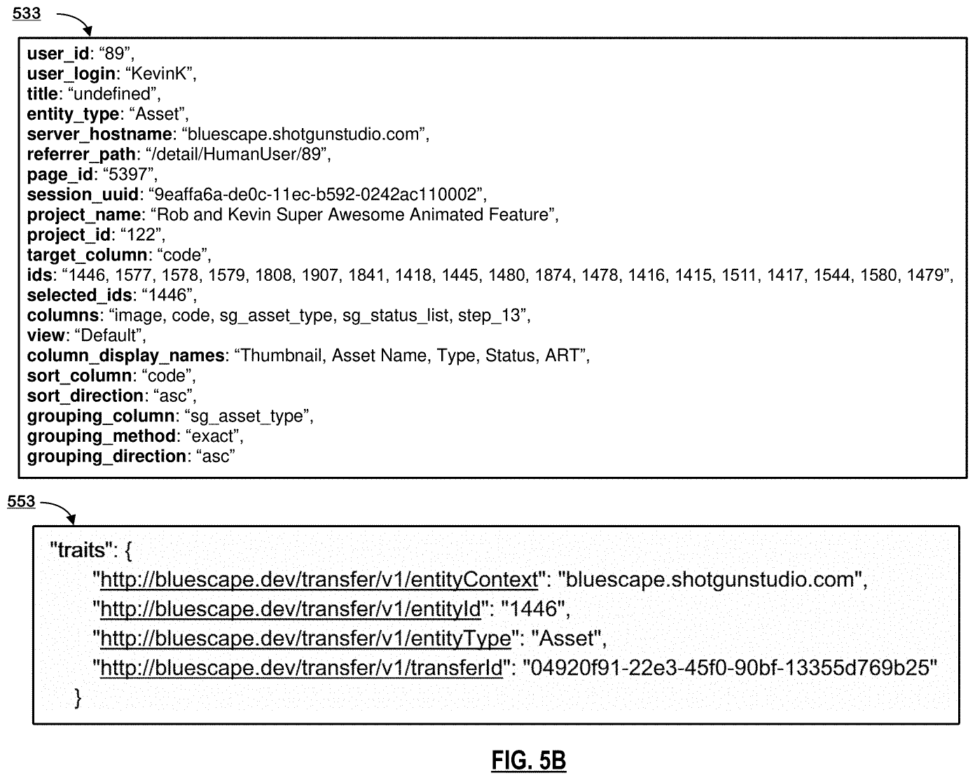

FIG. 5A presents an example payload (metadata) received with a “playlist” digital asset from the source of record application (or digital asset management system). The payload comprises a list of metadata related to the digital asset as key-value pairs presented in a box labeled 503. The metadata includes “user_id”, “user_login”, “title”, “entity_type”, “server_hostname”, “referrer_path”, “page_id”, “session_uuid”, “project_name”, “project_id”, “ids”, “selected_ids”, “cols”, “column_display_names”. The version management plugin 360 receives the payload including metadata with the digital asset from the digital asset management system. It can then translate the metadata to information that can be used by the collaboration system to identify versions of digital asset previously received from the digital asset management system. For example, the translation logic implemented by the version management plugin 360 can use the metadata presented in the box labeled 503 to generate information presented in a box 523. The translated information presented in the box 523 includes information such as “entityContext”, “entityId”, “entityType”, and “transferId”. The “entityContext” identifies a source of record application from which this digital asset is received. In this example, the “entityContext” stores a value “bluescape.shotgunstudio.com”. The “entityId” identifies a unique identifier for the digital asset which is “969”. The “entityType” indicates a type of digital asset which is “playlist” in the example presented in FIG. 5A. The “transferId” indicates a unique identifier generated for the currently received digital asset. This can be a string of a pre-defined length. The string can be composed of alphabets, numbers, special characters, symbols or a combination thereof. The “transferID” can be used by the version management plugin 360 to uniquely identify a particular transfer of digital assets from a digital asset management system 130 to the collaboration server 205. The version management plugin 360 can use this unique identifier to monitor and track the status of the particular transfer of digital assets. It can also use this identifier to access any relevant information related to the particular transfer. Examples of such relevant information are listed above such as “entity_type”, “selected_ids”, etc.

In one implementation, the “transferID” is a universally unique identifier (or UUID) that is generated randomly. It can also be generated using some user data such as a MAC address of the computing device, current date, current time, or a combination thereof. The version management plugin 360 can include logic to generate the UUID or it can use an external library such as “UUIDv4” to generate the “transferID”. The “transferID” as generated by “UUIDv4” can be 128 bits of data presented as 32 hexadecimal digits e.g., “a0fc8d68-469a-42a2-9268-c1d09a4377a1”. In this example of “transferID”, four bits are used to represent one digit, therefore the length of the UUID string is 32 which is obtained by dividing 128 by 4.

The collaboration system can use one or more fields in the metadata received from the digital asset management system with the digital asset to match the new digital asset to an existing digital asset. When the new digital asset's identifier such as “selected_ids” (504) metadata in the list of metadata presented in the box labeled 503 matches the identifier of a metadata in the database 205, the new digital asset is identified as a next version of the existing digital asset with matching identifier. The collaboration system can use one or more fields in the translated metadata in box 523 to match the new digital asset to an existing digital asset. For example, the collaboration system can match “entityID” (524) of the new digital asset to identifiers of digital assets stored in the database 205. If the “entityID” matches to identifier of an existing digital asset then the new digital asset is stored as a next version of the existing digital asset previously stored in the database 205.

The collaboration system keeps track of versions of digital system by updating the version information in the “versions” data structure. As new versions of a digital asset are received the version numbers are incremented. Each new version is assigned a next version number by incrementing the version number of the previously stored version. In one implementation, the system also stores time stamp of the digital asset creation which can be included in the metadata received from the digital asset management system. If such time stamp is not received from the digital asset management system, the collaboration system can generate a time stamp using the time and date at which the digital asset is received by the collaboration server. This time stamp data can also be used to organize the versions of digital assets. The digital assets with latest time stamp is assigned the most recent version number.

FIG. 5B presents another example of metadata for a digital asset received from a digital asset management system. In addition to the metadata in the example shown in FIG. 5A, the metadata shown in box 533 in FIG. 5B includes names of columns in which the received digital assets in a group can be organized. The metadata includes a metadata field labeled as “cols” which stores the values for columns, “image, code, sq_asset_type, sg_status_list, step_13”. Another metadata field labeled as “column_display_names” stores the values of column headers, “Thumbnail, Asset, Name, Type, Status, ART” for the five columns included in the “cols” metadata field. The metadata also includes other information about arrangement of columns such as “sort_column”, “sort_direction”, “grouping_column”, “grouping_method”, and “grouping_direction”. The values of these sort and group metadata fields are, “code”, “asc”, “sg_asset_type”, “exact”, and “asc”, respectively. The version management plugin translates the metadata to generate information that can be used by the collaboration system to place the digital asset in the workspace. The translated information is labeled as “traits” in as shown in a box 553 in FIG. 5B. It includes information such as “entityContext”, “entityId”, “entityType”, and “transferId”.

Various process steps for implementing automatic placement of versions of digital assets in a virtual workspace are presented below.

### Process Flowcharts

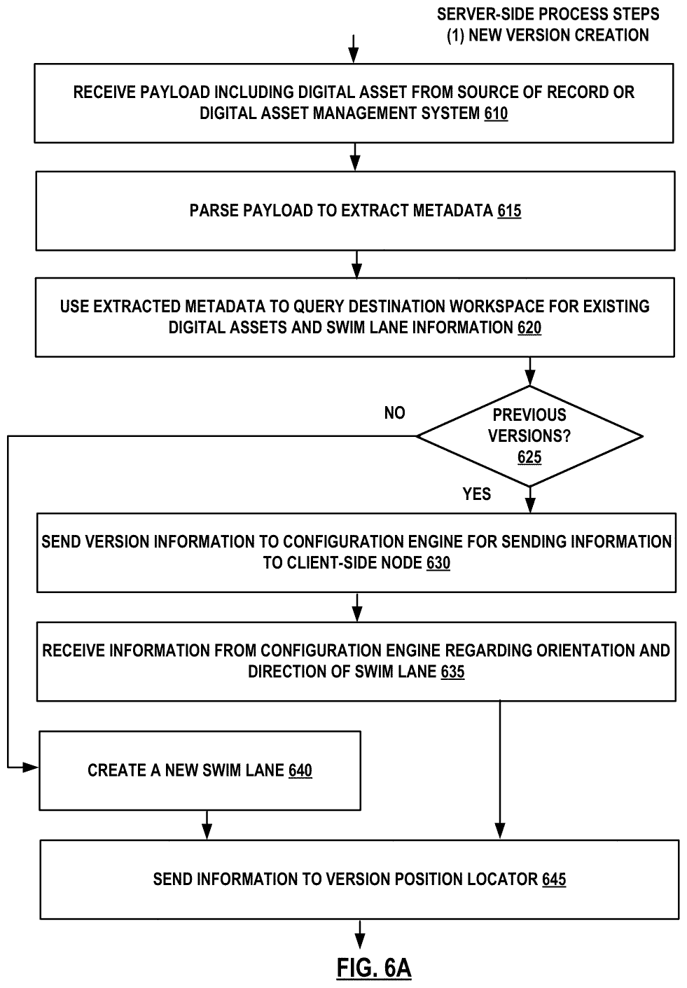

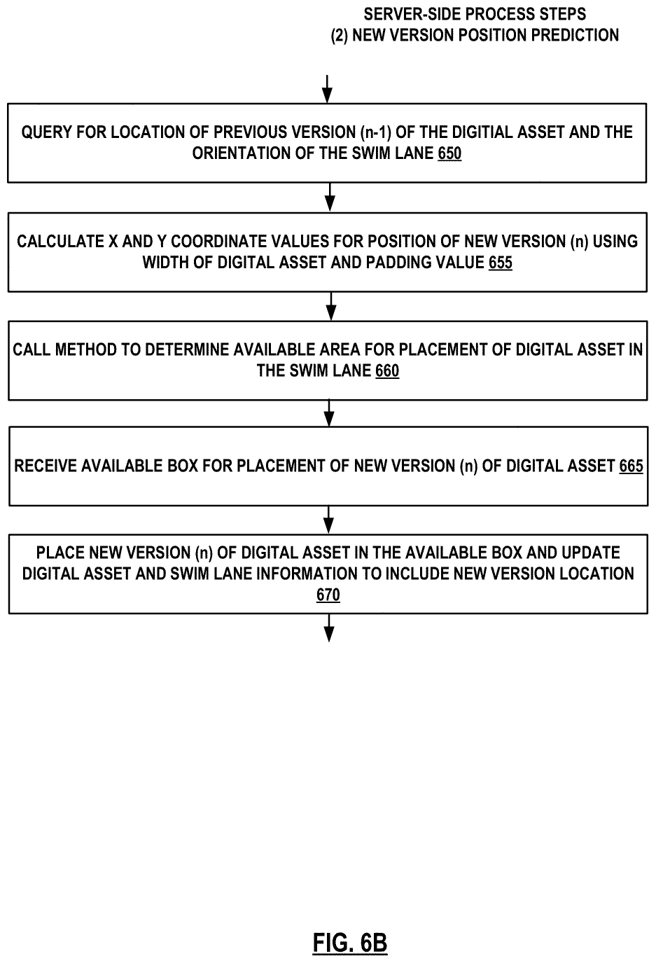

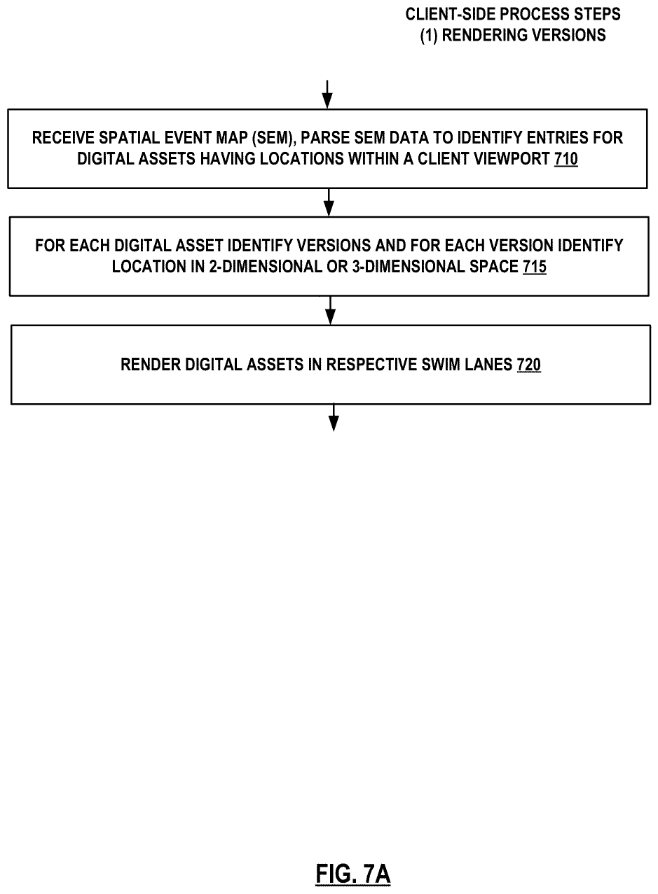

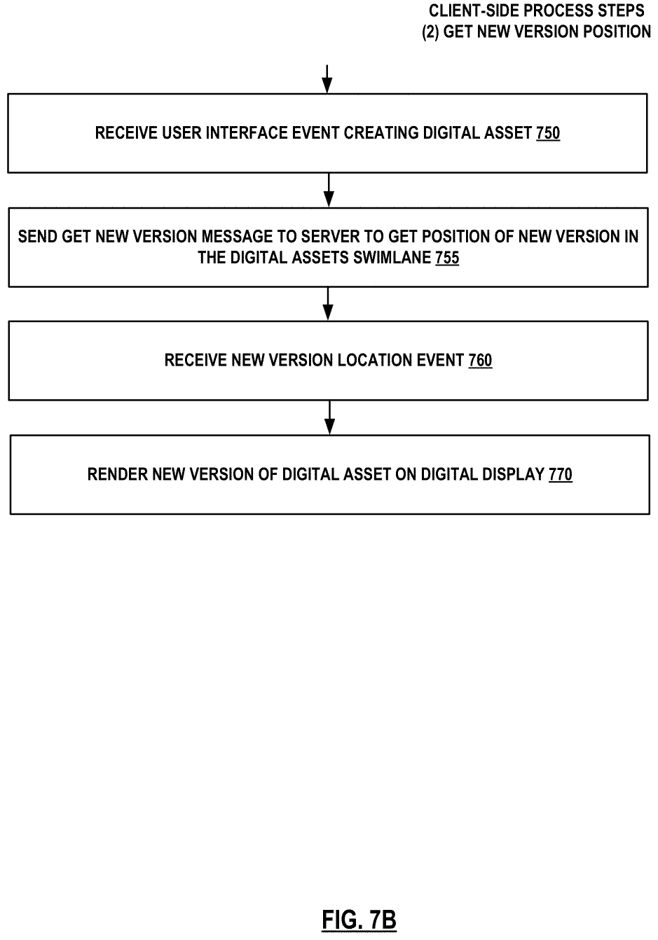

FIGS. 6A to 7B present process flowcharts for predictive placement of digital assets in workspaces for collaboration sessions. The flowcharts illustrate logic executed by a server (collaboration server), clients (network nodes), or both. The logic can be implemented using processors programmed using computer programs stored in memory accessible to the computer systems and executable by the processors, by dedicated logic hardware, including field programmable integrated circuits, and by combinations of dedicated logic hardware and computer programs. As with all flowcharts herein, it will be appreciated that many of the steps can be combined, performed in parallel or performed in a different sequence without affecting the functions achieved. In some cases, as the reader will appreciate, a re-arrangement of steps will achieve the same results only if certain other changes are made as well. In other cases, as the reader will appreciate, a re-arrangement of steps will achieve the same results only if certain conditions are satisfied. Furthermore, it will be appreciated that the flow charts herein show only steps that are pertinent to an understanding of the technology, and it will be understood that numerous additional steps for accomplishing other functions can be performed before, after and between those shown.

### Server-Side Process for Predictive Placement of Digital Assets

FIGS. 6A and 6B present server-side process steps for receiving digital assets from a digital asset management system and processing the digital assets for predictive placement in workspaces for collaboration sessions.

FIG. 6A presents process steps for receiving digital assets from a digital asset management system and using the metadata to determine a version and location in workspace for placing the digital asset. The process starts when the collaboration system receives a payload including the digital asset from the digital asset management system (operation 610). In one implementation, the version management plugin 310 receives the payload including the digital asset and the metadata for the digital asset. The version management plugin 310 includes logic to parse the payload and extract metadata for the digital asset (operation 615). Examples of metadata that can be sent with the digital asset in the payload are presented in FIGS. 5A and 5B.

The server includes logic to use the extracted metadata to query the workspace to determine previous versions of the received digital asset (operation 620). If a previous version exists (operation 625), then the system can position the digital asset in the existing swim lane, otherwise, the system can create a new swim lane (operation 640). The system sends the results of the query i.e., previous version information to the client-side node to get input from the user. The servers send the current version's version number that is already present in the workspace and can also send the orientation and direction (e.g., left to right or top to bottom) of the swim lane in the workspace. This information can be displayed on the configuration page for the user to review and make any changes if required (operation 630). The server receives the configuration information from the client-side node (operation 635). The server sends the current version's location, the new version's width information, the padding distance between versions to the version position locator (operation 645).

FIG. 6B presents process steps that version locator performs to locate a position in the swim lane at which the new version of the digital asset can be placed. If there are other digital assets manually positioned in the swim lane, the version position locator, determines a next location in the swim lane at which the new version can be positioned. The server then places the new version in the location determined by the version position locator.

The process starts at an operation 650 at which the version position locator queries the position of the previous version to determine the location along X and Y axes. The version position locator determines the values for X and Y coordinates as follows (operation 655). Suppose the previous version's (N−1) position is “x” along X-axis, the version position locator calculator determines the new version's (N) location by adding the width of the previous version and the padding between two versions in the value of x. Note that in this example, it is assumed that “x” and “y” values represent the top-left corner of the box containing the digital asset.

N·x=(N−1)·x+(N−1)·width+Padding Equation (1)

Suppose the previous version's (N−1) position is “y” along Y-axis, the version position locator calculator determines the new version's location matching it to the previous version's position along Y-axis. This is because, in this example, it is assumed the swim lane is horizontally oriented along X-axis and direction of placement of digital assets in the swim lanes is from left to right. Therefore, the position along Y-axis remains the same as new versions are added on the right wide of the previous version in the same swim lane.

N·y=(N−1)·y Equation (2)

The version position locator then calls a method “findAvailableArea” to determine available area in the swim lane for placing the new version of the digital asset (operation 660). This method takes as input the destination workspace, the “x” and “y” locations for the new version as calculates in the previous operation, the width and height of the new version (N) of the digital asset, and the direction of the orientation vector such as left to right, top to bottom etc. The “findAvailableArea” method determines location of a box in the swim lane for the digital asset that can contain the new version of the digital asset. The method uses the width and height of the new version and the positions “x” and “y” for the new version calculated by using Equations (1) and (2) above when determining a place to position the new version in the swim lane. This method also considers any other digital assets that are placed in the swim lane manually by a user, as shown in the example in FIG. 4B. The collaboration server receives available location for placing the new version from the method (operation 665). The server then places the new version in the box (or area) returned by the “findAvailableArea” method (operation 670).

### Client-Side Process for Predictive Placement of Digital Assets

FIG. 7A presents client-side process steps for predictive placement of versions of digital assets in a workspace. The client-side computing device (or network node) receives a spatial event map including digital assets for display on the workspace during a collaboration session. The client-side computing device parses the spatial event map to identify entries for digital assets having locations within a client-side viewport (operation 710). For each digital asset, the client-side computing device identifies the versions of the digital asset (operation 715) and places the digital assets in the swim lanes for respective digital asset as defined by their locations in 2D or 3D spatial coordinates. The client-side computing device renders the digital assets in their respective swim lanes (operation 720).

FIG. 7B presents client-side process steps when input event is processed by a client-side network node to update the workspace in response to creation of a new digital asset. The digital asset can be created from within the workspace either by editing an existing digital asset or creating a new digital asset (operation 750). Note that this method of creation of a new version of a digital asset is different from receiving a new version of a digital asset (or a group of digital assets) from an external system such as a digital asset management system. The client-side computing device sends an update event to the collaboration server with information about the new digital asset (new version message to get position of new version in the digital assets swimlane) (operation 755). The collaboration server can receive and then process the new digital asset (new version location event) using operations described in the flow charts presented in FIGS. 6A and 6B. The client-side computing device renders the new version of digital asset on the digital display linked with the client-side computing device (operation 770).

### System Components for Predictive Placement of Digital Assets

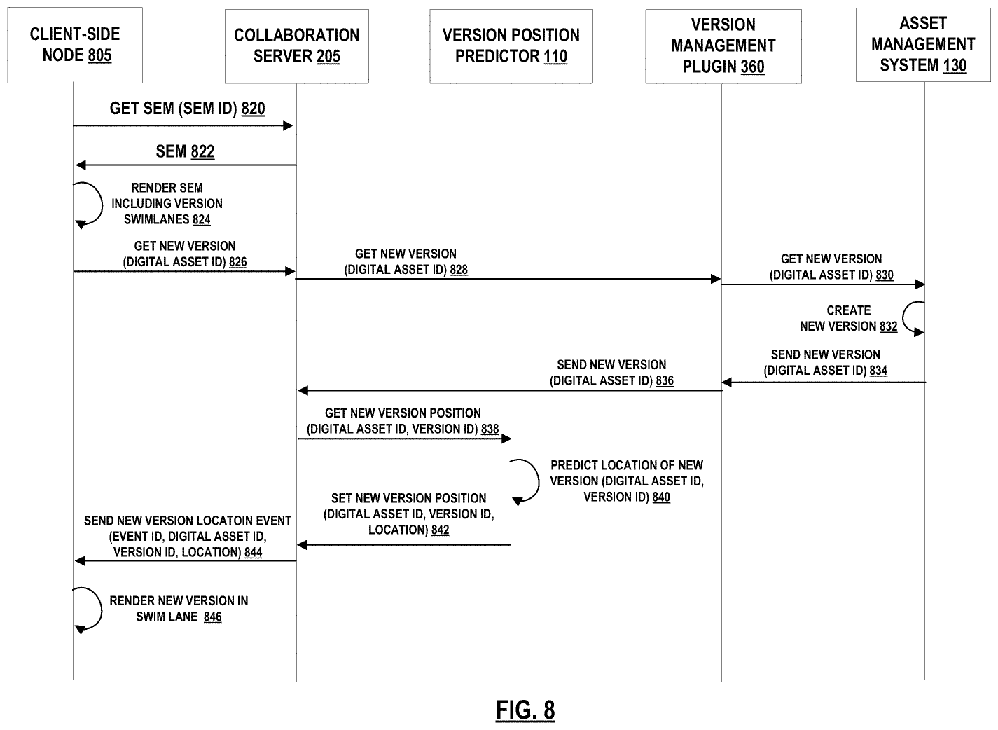

FIG. 8 presents a message sequence diagram illustrating messages sent between various system components (or engines) for predictive placement of digital assets. Note that there can be additional authentication messages sent by the client-side node to get access to the server and then provide required credentials to the collaboration server. The message sequence diagram does not show the authentication process as it is not the focus of this discussion. The process can start when a client-side computing device (or network node) 805 sends a “get SEM (SEM ID)” message 820 to the collaboration server 205. The message 820 includes an identifier “SEM ID” for the spatial event map requested by the client-side computing device. The collaboration server sends the requested SEM via “SEM” message 822 to the client-side computing device 805. The client-side computing device 805 renders the digital assets including the swim lanes for respective versions of digital assets on the display linked to the computing device 805 (via message 824). The swim lanes can be identified using graphical constructs, such as lines, arrows and/or boxes or the swim lanes can be identified without specifical graphical constructs, but rather by the alignment of the versions of the digital assets in a particular direction (e.g., horizontal, vertical, diagonal, etc.).

The client-side computing device 805 sends a message “get new version (digital asset ID)” message 826 to the collaboration server 205. The client-side computing device sends this message to request a new version of a digital asset or a new digital asset which for which a prior version does not exist in the spatial event map. The collaboration server then sends a “get new version (digital asset ID)” message to 828 to the version management plugin 360 which can then send a message “get new version (digital asset ID)” 830 to the asset management system 130 to get the new version of the digital asset. In an alternative sequence, the asset management system 130 may send a digital asset or a new version of an existing digital asset to the collaboration server 205 without receiving the request message from the collaboration server. This could be triggered by the automatic or manual identification of the new version of the digital asset by the asset management system 130. The asset management system 130 can also create a new version 832 of an existing digital asset based on the instruction of a user and/or based on other received information. A payload sent by the asset management system 130 can be first received by the version management plugin (or system) 360 and processed to extract metadata. The collaboration server can then send the digital asset to the client-side computing device 805.

More specifically, the asset management system 130 can generate new digital assets or new versions of existing digital assets (i.e., “create new version” digital asset 832). The digital asset management system 130 sends a new version of the digital asset via a “send new version (digital asset ID)” message 834 (along with the payload) to the version management plugin 360. The payload sent by the digital asset management system 130 to the version management plugin (or system) 360 can include metadata related to the digital asset. Examples of such metadata are presented in FIGS. 5A and 5B. The version management plugin 360 parses the metadata and sends the parsed information to the collaboration server 205 along with the new version of the digital asset via a “send new version (digital asset ID)” message 836.

The collaboration server 205 sends a “get new version position (digital asset ID, version ID)” message 838 to the version position predictor 110. The version position predictor 110 includes logic to determine the location in the workspace where the new version is to be placed (i.e., “predict location of new version (digital asset ID, version ID)” 840). The version position predictor 110 sends a “send new version position (digital asset ID, version ID, location)” message 842 to the collaboration server 205.

The collaboration server 205 sends the location of the new version to the client-side computing device 805 via a “send new version location event (event ID, digital asset ID, version ID, location” message 844. The client-side computing device 805 renders the new version of the digital asset on the display linked to the computing device (i.e., “render new version in swim lane” 846).

### Computer System

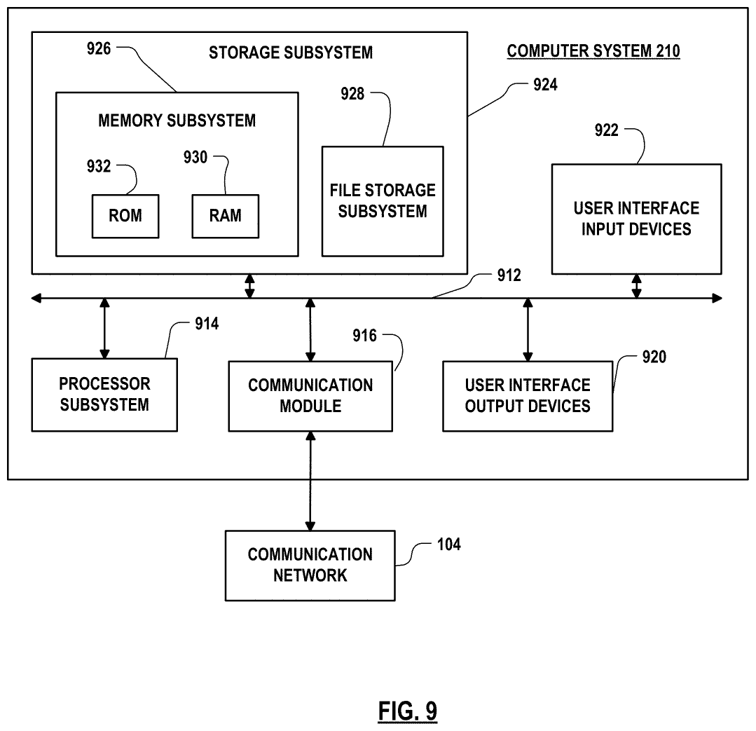

FIG. 9 is a simplified block diagram of a computer system, or network node, which can be used to implement the client-side functions (e.g., computer system 210) or the server-side functions (e.g. server 205) in a distributed collaboration system. A computer system typically includes a processor subsystem 914 which communicates with a number of peripheral devices via bus subsystem 912. These peripheral devices may include a storage subsystem 924, comprising a memory subsystem 926 and a file storage subsystem 928, user interface input devices 922, user interface output devices 920, and a communication module 916. The input and output devices allow user interaction with the computer system. Communication module 916 provides physical and communication protocol support for interfaces to outside networks, including an interface to communication network 204, and is coupled via communication network 204 to corresponding communication modules in other computer systems.

Communication network 204 may comprise many interconnected computer systems and communication links. These communication links may be wireline links, optical links, wireless links, or any other mechanisms for communication of information, but typically it is an IP-based communication network, at least at its extremities. While in one embodiment, communication network 204 is the Internet, in other embodiments, communication network 204 may be any suitable computer network.

The physical hardware component of network interfaces are sometimes referred to as network interface cards (NICs), although they need not be in the form of cards: for instance they could be in the form of integrated circuits (ICs) and connectors fitted directly onto a motherboard, or in the form of macrocells fabricated on a single integrated circuit chip with other components of the computer system.

User interface input devices 922 may include a keyboard, pointing devices such as a mouse, trackball, touchpad, or graphics tablet, a scanner, a touch screen incorporated into the display (including the touch sensitive portions of large format digital display such as 102c), audio input devices such as voice recognition systems, microphones, and other types of tangible input devices. In general, use of the term “input device” is intended to include all possible types of devices and ways to input information into the computer system or onto computer network 104.

User interface output devices 920 may include a display subsystem, a printer, a fax machine, or non-visual displays such as audio output devices. The display subsystem may include a cathode ray tube (CRT), a flat panel device such as a liquid crystal display (LCD), a projection device, or some other mechanism for creating a visible image. In the embodiment of FIG. 1B, it includes the display functions of large format digital display such as 102c. The display subsystem may also provide non-visual display such as via audio output devices. In general, use of the term “output device” is intended to include all possible types of devices and ways to output information from the computer system to the user or to another machine or computer system.

Storage subsystem 924 stores the basic programming and data constructs that provide the functionality of certain embodiments of the present invention.

The storage subsystem 924 when used for implementation of server-side network-nodes, comprises a product including a non-transitory computer readable medium storing a machine-readable data structure including a spatial event map which locates events in a workspace, wherein the spatial event map includes a log of events, entries in the log having a location of a graphical target of the event in the workspace and a time. Also, the storage subsystem 924 comprises a product including executable instructions for performing the procedures described herein associated with the server-side network node.

The storage subsystem 924 when used for implementation of client side network-nodes, comprises a product including a non-transitory computer readable medium storing a machine readable data structure including a spatial event map in the form of a cached copy as explained below, which locates events in a workspace, wherein the spatial event map includes a log of events, entries in the log having a location of a graphical target of the event in the workspace and a time. Also, the storage subsystem 924 comprises a product including executable instructions for performing the procedures described herein associated with the client-side network node.

For example, the various modules implementing the functionality of certain embodiments of the invention may be stored in storage subsystem 924. These software modules are generally executed by processor subsystem 914.

Memory subsystem 926 typically includes a number of memories including a main random-access memory (RAM) 930 for storage of instructions and data during program execution and a read only memory (ROM) 932 in which fixed instructions are stored. File storage subsystem 928 provides persistent storage for program and data files, and may include a hard disk drive, a floppy disk drive along with associated removable media, a CD ROM drive, an optical drive, or removable media cartridges. The databases and modules implementing the functionality of certain embodiments of the invention may have been provided on a computer readable medium such as one or more CD-ROMs and may be stored by file storage subsystem 928. The host memory 926 contains, among other things, computer instructions which, when executed by the processor subsystem 914, cause the computer system to operate or perform functions as described herein. As used herein, processes and software that are said to run in or on the “host” or the “computer,” execute on the processor subsystem 914 in response to computer instructions and data in the host memory subsystem 926 including any other local or remote storage for such instructions and data.

Bus subsystem 912 provides a mechanism for letting the various components and subsystems of a computer system communicate with each other as intended. Although bus subsystem 912 is shown schematically as a single bus, alternative embodiments of the bus subsystem may use multiple busses.

The computer system itself can be of varying types including a personal computer, a portable computer, a workstation, a computer terminal, a network computer, a television, a mainframe, a server farm, or any other data processing system or user device. In one embodiment, a computer system includes several computer systems, each controlling one of the tiles that make up the large format display such as 102c. Due to the ever-changing nature of computers and networks, the description of computer system 210 depicted in FIG. 9 is intended only as a specific example for purposes of illustrating the preferred embodiments of the present invention. Many other configurations of the computer system are possible having more or less components than the computer system depicted in FIG. 9. The same components and variations can also make up each of the other devices 102 in the collaboration environment of FIG. 1, as well as the collaboration server 205 and database 206.

Certain information about the drawing regions active on the digital display 102c are stored in a database accessible to the computer system 210 of the display client. The database can take on many forms in different embodiments, including but not limited to a MongoDB database, an XML database, a relational database, or an object-oriented database.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present technology may consist of any such feature or combination of features. In view of the foregoing description, it will be evident to a person skilled in the art that various modifications may be made within the scope of the technology.

The foregoing description of preferred embodiments of the present technology has been provided for the purposes of illustration and description. It is not intended to be exhaustive or to limit the technology to the precise forms disclosed. Obviously, many modifications and variations will be apparent to practitioners skilled in this art. For example, though the displays described herein are of large format, small format displays can also be arranged to use multiple drawing regions, though multiple drawing regions are more useful for displays that are at least as large as 12 feet in width. In particular, and without limitation, any and all variations described, suggested by the Background section of this patent application or by the material incorporated by reference are specifically incorporated by reference into the description herein of embodiments of the technology. In addition, any and all variations described, suggested or incorporated by reference herein with respect to any one embodiment are also to be considered taught with respect to all other embodiments. The embodiments described herein were chosen and described in order to best explain the principles of the technology and its practical application, thereby enabling others skilled in the art to understand the technology for various embodiments and with various modifications as are suited to the particular use contemplated. It is intended that the scope of the technology be defined by the following claims and their equivalents.

What is claimed is:

1. A server-side network node of a collaboration system hosting a collaboration session, between client-side network nodes, each including a display having a physical display space and a processor, the server-side network node being configured with logic to implement operations comprising:
establishing a collaboration session between the client-side network nodes;
receiving an identification of a virtual workspace from at least a first client-side network node wherein the virtual workspace comprises locations having virtual coordinates;
receiving, from a digital asset management system, an updated digital asset and an identifier of the updated digital asset;
querying the virtual workspace for a version of a particular digital asset within the virtual workspace having an identifier that matches the identifier of the updated digital asset;
saving the updated digital asset as a subsequent version of the particular digital asset;
determining a location for placing the subsequent version of the particular digital asset in a swim lane, for the version of the particular digital asset, within the virtual workspace, wherein the location for placing the subsequent version of the particular digital asset is determined in dependence on (i) a width of the subsequent version of the particular digital asset and (ii) a padding distance between the version of the particular digital asset and the subsequent version of the particular digital asset; and
providing, to the client-side network nodes, a spatial event map identifying events in the virtual workspace, the events identified by the spatial event map being related to the version of the particular digital asset and the subsequent version of the particular digital asset within the virtual workspace, wherein the spatial event map allows for rendering, in the display space on the display of each of the client-side network nodes, the version of the particular digital asset and the subsequent version of the particular digital asset in the swim lane within the virtual workspace.

2. The system of claim 1, wherein the server-side network node is further configured with logic to implement operations including:
creating the swim lane within the virtual workspace for placing one or more digital assets, wherein a height of the swim lane is equal to or greater than a height of a tallest of the one or more digital assets and a direction of the swim lane is along an orientation vector according to which the one or more digital assets are aligned in dependence on version numbers; and
placing the subsequent version of the particular digital asset in the swim lane and adjacent to the version of the particular digital asset in the direction of the orientation vector.

3. The system of claim 2, wherein the orientation vector is along a horizontal axis in a two-dimensional virtual workspace.

4. The system of claim 2, wherein the orientation vector is normal to a plane in a three-dimensional virtual workspace.

5. The system of claim 2, wherein the server-side network node is further configured with logic to implement operations including:
detecting an interfering digital asset positioned in the virtual workspace that is (i) at least partially covering an area in the swim lane and (ii) positioned at a location after the location of the version of the particular digital asset along the direction of the orientation vector; and
determining a target location in the swim lane to place the subsequent version of the particular digital asset, wherein the target location is positioned in the swim lane along the direction of the orientation vector and does not overlap with the location occupied by the interfering digital asset.

6. The system of claim 1, wherein the server-side network node is further configured with logic to implement operations including:
parsing a payload including the updated digital asset to extract metadata related to the updated digital asset, wherein the metadata includes at least one of a user identifier, a user login, a title of the updated digital asset, an entity type of the updated digital asset, a project name, a project identifier and a server hostname,
saving the extracted metadata with the subsequent version of the particular digital asset.

7. The system of claim 6,
wherein the updated digital asset comprises of a plurality of child digital assets nested in the updated digital asset, and
wherein the parsing of the payload further includes extracting identifiers for the child digital assets and saving the extracted metadata with the subsequent version of the particular digital asset.

8. The system of claim 7,
wherein the parsing of the payload further includes extracting metadata related to the child digital assets including at least one of columns, column display names, sort criterion, sort direction, group criterion, group method and group direction, wherein the server-side network node is further configured with logic to implement operations including:
arranging the child digital assets in the swim lane in a tabular format using at least one of the extracted metadata wherein the tabular format displays the child assets nested inside the subsequent version of the particular digital asset in columns arranged in dependence upon at least one or more of the extracted metadata related to the child digital assets.

9. The system of claim 6, wherein the server-side network node is further configured with logic to implement operations including:
translating the metadata to identify at least one of an entity context, an entity identifier and an entity type,
generating a transfer identifier comprising alpha numeric characters, and
associating (i) the at least one of the entity context, the entity identifier and the entity type and (ii) the transfer identifier with the updated digital asset, as received from the digital asset management system.

10. The system of claim 1, wherein the querying the virtual workspace for the version of the particular digital asset further includes using the identifier of the updated digital asset to search a database storing the spatial event map including a plurality of digital assets and their respective identifiers, and wherein the plurality of digital assets include the version of the particular digital asset with the identifier that matches the identifier of the updated digital asset.

11. The system of claim 1, wherein the digital asset management system includes logic to generate the updated digital asset by changing at least one property of the version of the particular digital asset and the receiving of the updated digital asset from the digital asset management system further includes receiving the updated digital asset including the at least one changed property, wherein the change in the at least one property of the version of the particular digital asset includes at least one of a color variance, shadow variance, angle of view variance, light variance, object location variance, object size variance and color depth variance.

12. The system of claim 1, wherein the server-side network node is further configured with logic to implement operations including:
parsing a payload including the updated digital asset to extract metadata related to the updated digital asset, wherein the metadata includes at least a time stamp indicating a date and a time of creation of the updated digital asset by the digital asset management system,
using the time stamp metadata of the updated digital asset to assign a version number to the updated digital asset.

13. The system of claim 1, wherein the server-side network node is further configured with logic to implement operations including:
determining a number of intermediate versions of the particular digital asset between a first version of the particular digital asset and a last version of the particular digital asset;
generating a plurality of graphical constructs to represent the intermediate versions of the particular digital asset; and
providing, to the client-side network nodes, the plurality of graphical constructs for rendering in place of the intermediate versions of the particular digital asset.

14. A non-transitory computer-readable recording medium having computer instructions recorded thereon, the computer instructions, when executed by one or more processors, causing the one or more processors to perform the operations of claim 1.

15. A method of performing the operations of claim 1.

16. A collaboration system hosting a collaboration session, the collaboration system comprising:
a client-side network node including a display having a physical display space, the client-side network node being configured with logic to implement operations including:
retrieving, from a server-side network node, a spatial event map identifying events in a virtual workspace, the events identified by the spatial event map being related to a version of a particular digital asset and a subsequent version of the particular digital asset within the virtual workspace wherein the version of the particular digital asset and the subsequent version of the particular digital asset are placed in a swim lane and a location for placing the subsequent version of the particular digital asset in the swim lane is determined in dependence on (i) a width of the subsequent version of the particular digital asset and (ii) a padding distance between the version of the particular digital asset and the subsequent version of the particular digital asset; identifying a local client viewport in the virtual workspace, the local client viewport representing a location and dimensions in the virtual workspace including a plurality of digital assets including the version of the particular digital asset and the subsequent version of the particular digital asset; and
rendering, in the display space on the display, the version of the particular digital asset and the subsequent version of the particular digital asset in the swim lane within the virtual workspace.

17. The client-side network node of claim 16, wherein a height of the swim lane is equal to or greater than a height of a tallest of the one or more digital assets and a direction of the swim lane is along an orientation vector according to which the one or more digital assets are aligned in dependence on version numbers.

18. The client-side network node of claim 17, wherein the orientation vector is along a horizontal axis in a two-dimensional virtual workspace.

19. A non-transitory computer-readable recording medium having computer instructions recorded thereon, the computer instructions, when executed by one or more processors, causing the one or more processors to perform the operations of claim 16.

20. A method of performing the operations of claim 16.
